(19) United States
(12) Patent Application Publication
(10) Pub. No.: US 2008/0195925 A1
(43) Pub. Date: Aug. 14, 2008

(54) Compressed Media Files with Intrinsic Supplementary Content

(76) Inventor: Donna Marie Auguste, Denver, CO (US)

Correspondence Address: TIPS GROUP;c/o Intellevate LLC, P. O. BOX 52050, Minneapolis, MN, 52050, US

(21) Appl. No.: 10/562,388

(22) PCT Filed: Jun. 25, 2004
(86) PCT No.: PCT/US2004/020302

§ 371 Date: Mar. 31, 2008

Related U.S. Application Data
(60) Provisional application No. 60/483,441, filed on Jun. 26, 2003.

(51) Int. Cl. G06F 17/00

(52) U.S. Cl. 715/201

(57) ABSTRACT

A method for combining compressed media files with intrinsic supplementary content includes, in one embodiment, obtaining a compressed media file and a digitally encoded supplementary content file. The digitally encoded supplementary content file is then combined with the compressed media file into a final compressed media file. In other embodiments, various media files (some of which may be supplementary content) are combined before or after compression, or both. Moreover, the files may be combined in various orders, or interleaved and/or intermingled as appropriate.

### FIELD OF THE INVENTION

The present invention relates generally to electronic media files such as audio, visual, and audio-visual files, and more particularly to systems for incorporating additional content into electronic audio files.

### BACKGROUND OF THE INVENTION

FIG. 1 is a timeline 102 illustrating discrete electronic media files, specifically media banner file #1 104, master file #2 106 and media banner file #3 108 as they are found in the prior art. Each file 104, 106 and 106 can each contain narration, music, video and combinations thereof. Since each file 104, 106 and 108 are discrete unto themselves, each one is usually played separately to deliver the information contained therein.

A problem occurs when it is desired to merge files 104, 106 and 108 into one continuous stream contained in a singular file. Yet another problem occurs when it is desired to overlap one or more of files 104, 106 and 108. While it is possible to play the files 104, 106 and 108 on simultaneous multiple streams, this is often tedious as it does not lend well to broadcast over a network and still leaves the aforementioned problem of having multiple files to manipulate. Furthermore, these files cannot be transported as a unit. For example, they cannot be downloaded from a web server over the Internet in the form of a unitary MP3 file.

Accordingly, what is needed is a method and apparatus to conveniently merge audio files for linear playback as well as overlaying audio files onto each other, at selected points, such that a single audio file results.

### SUMMARY OF THE INVENTION

The present invention fills these needs by providing a method and system for appending and overlaying media files of various types. These can then be formed into compressed media files for transmission or storage. It should be appreciated that the present invention can be implemented in numerous ways, including a method and system. Several inventive embodiments of the present invention are described below.

In one embodiment, the invention is a method for combining compressed media files with intrinsic supplementary content. The method for combining compressed media files with intrinsic supplementary content, includes obtaining a compressed media file and a digitally encoded supplementary content file. The digitally encoded supplementary content file is then combined with the compressed media file into a final compressed media file.

In another embodiment, the invention is a method of enhancing a media file with intrinsic supplementary content. The method includes obtaining a media file. The method also includes combining supplementary content with the media file to create a compressed unitary media file with supplementary content.

In yet another embodiment, the invention is a method. The method includes receiving a media file. The method also includes receiving a first supplemental media file. The method further includes combining the media file with the first supplemental media file to form a combined media file.

In another embodiment, the invention is a system. The system includes a processor, a memory coupled to the processor, and a network interface coupled to the processor. The processor is to receive a media file. The processor is also to receive a first supplemental media file. The processor is farther to combine the media file with the first supplemental media file to form a combined media file. In still another embodiment, the invention is an apparatus. The apparatus includes means for receiving media files, means for combining media files, and means for exporting media files.

Various embodiment allow for a single file including multiple original media files which can be created and propagated without the need to locate and manipulate multiple files. Additionally, an audio file can be overlayed such that both streams can be heard via a single file without the need to setup multiple streams.

These and other advantages of the present invention will become apparent to those skilled in the art after reading the following descriptions and studying the various figures of the drawings.

### BRIEF DESCRIPTION OF THE DRAWINGS

FIG. 1 is a timeline illustrating the temporal sequence of the playing of discrete electronic media files of the prior art.

FIG. 2 is a block diagram of an embodiment of a system for production and transmission of bannered music files.

FIG. 3 is a timeline showing a temporal configuration of a first embodiment of a Bannered File as a complete Digital Music Package.

FIG. 4 is a timeline showing a temporal configuration of a second embodiment of a Bannered File as a complete Digital Music Package.

FIG. 5 is a timeline showing a temporal configuration of a second embodiment of a Bannered File as a complete Digital Music Package.

FIG. 6 is a flow chart that illustrates the functionality of filters on the playback of a Package, in an embodiment.

FIG. 7 is a block diagram that demonstrates how a Music File is created, in an embodiment.

FIG. 8 is a block diagram that demonstrates how an Audio Banner file is created, in an embodiment.

FIG. 9 is a block diagram that demonstrates how a Digital Music Package is created, in an embodiment.

### DETAILED DESCRIPTION OF THE INVENTION

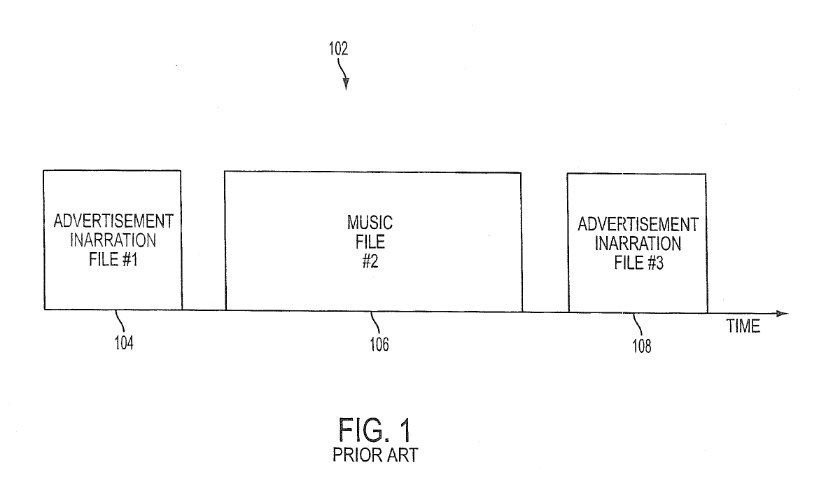

FIG. 1 was described with reference to the prior art. The present invention provides a system and method for appending or combining and mixing media files of various types into a singular media file. The resulting singular media file is suitable for playback and transmission over a network. By “media file” it is meant a file including audio and/or visual media content. For example, a media file includes an audio file, a video file, an audio-visual file, etc. Additionally, the present invention can be utilized using various media standards such as .mp3, .aac (Apple Computer Inc. compressed music file standard), .avi and the like. This preceding list is not meant to be restrictive but merely an illustration of some of the standards the present invention can be practiced on. Additionally, the present invention is envisioned to be compatible with new standards as they become available. Moreover, the present invention is described in an illustrative rather than restrictive manner in general, the spirit and scope of the invention is limited only by the appended claims.

In one embodiment, the invention is a method for combining compressed media files with intrinsic supplementary content. The method for combining compressed media files with intrinsic supplementary content, includes obtaining a compressed media file and a digitally encoded supplementary content file. The digitally encoded supplementary content file is then combined with the compressed media file into a final compressed media file.

In various embodiments, variations on the methods or apparatuses may be involved. For example, the supplementary content may include a first supplementary media file and a second supplementary media file. Similarly, in some instances, the first supplementary media file is an advertisement (a commercial message) or is commentary (such as a statement about a media file, about news, or an opinion for example). Moreover, in some instances, the second supplementary media file is an advertisement or is commentary. Combining supplementary content with the media file may include loading the supplementary content and loading the media file. Combining supplementary content with the media file may also include forming a unitary media file with supplementary content including the media file and the supplementary content. Furthermore, combining supplementary content with the media file may also include compressing the unitary media file with supplementary content to form a compressed unitary media file with supplementary content. Moreover, combining supplementary content with the media file may also include exporting the compressed unitary media file with supplementary content. Additionally, compressing the unitary media file with supplementary content may include encoding the unitary media file with supplementary content.

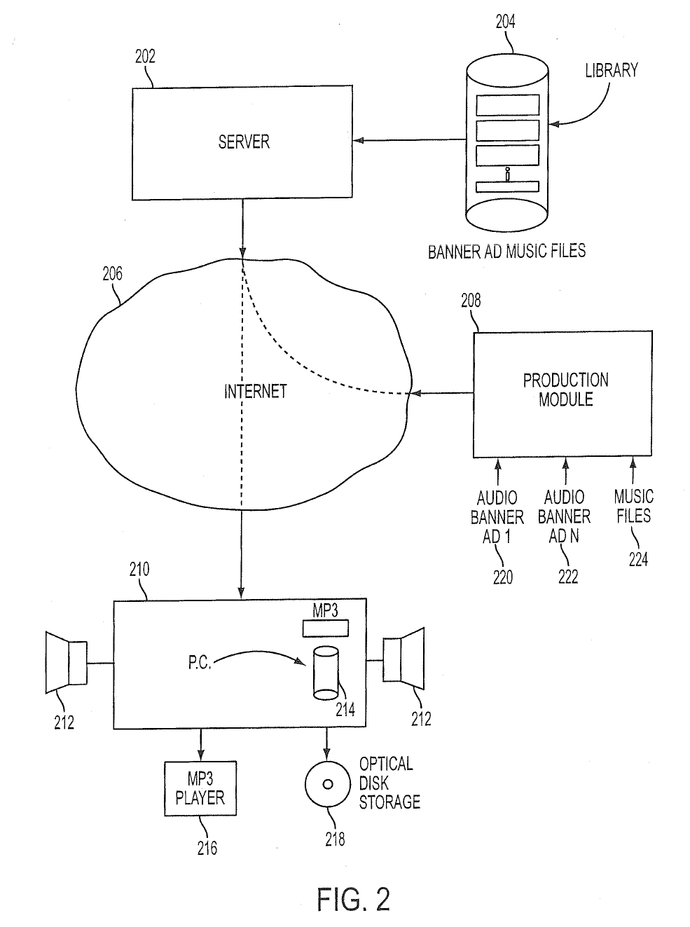

The following descriptions of the figures provide additional detail about various embodiments. FIG. 2 is a block diagram of an embodiment of a system 200 for production and transmission of bannered files. Included in system 200 is a network 206 (such as the Internet), a server 202, a production module 208 and a personal computer 210. The server 202, production module 208 and personal computer 210 are all coupled to the network 206. Also included is a library 204, coupled to the server 202, that is used for storing bannered files. Personal computer 210 may also optionally include speakers 212, an MP3 player 216 and an optical disk storage device 218. Computer 210 also includes a persistent storage device 214. The terms “audio banner” and “bannered file” can be used interchangeably and refers to a file that is added to an existing media file. Additionally, the terms “bannered file”, “package” and “digital music package” and other similar combinations can be used interchangeably and refer to a media file including supplementary content.

A production module 208 may combine the Audio Banner file #1 220 up to Audio Banner file #n 222 with a Music File 224. The resulting Package (not shown) is transferred via the Internet 206 to a server 202, where is can reside in a library 204 that contains bannered files. Via the Internet 206, a listener, via a personal computer 210, can retrieve the bannered file and playback the Package on a personal computer 210 using decoding and playback software such as MP3 players 216, Microsoft Windows Media player (not shown), and Apple's iTunes player (not shown). The bannered file can also be stored onto an optical disk 218, CDROM (not shown), or other secondary media (not shown). Note that the server 202 and the production module 208 may be implemented as computers similar to personal computer 210. Moreover, the production module 208 may be implemented as software on a machine such as a computer similar to personal computer 210.

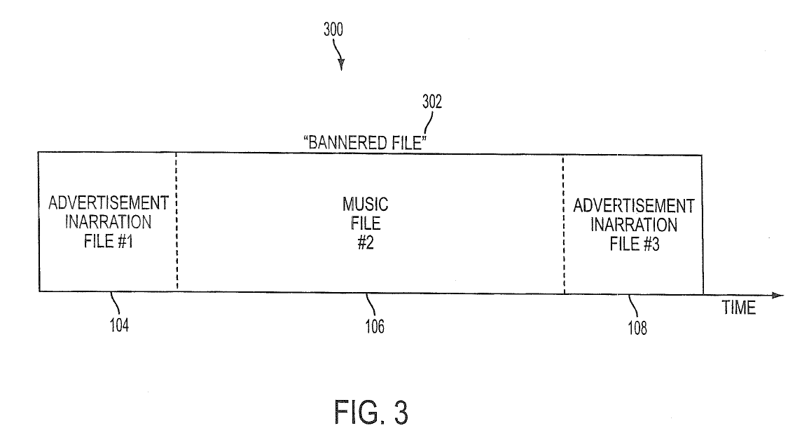

The media files may be combined in various orders or manners. FIG. 3 is a timeline 300 showing a temporal configuration of a first embodiment of a Bannered File 302 as a complete Digital Music Package. In this diagram, media Banner File #1 104 will playback first from the Package 302, followed by master File #2 106, then followed by media Banner File #3 108.

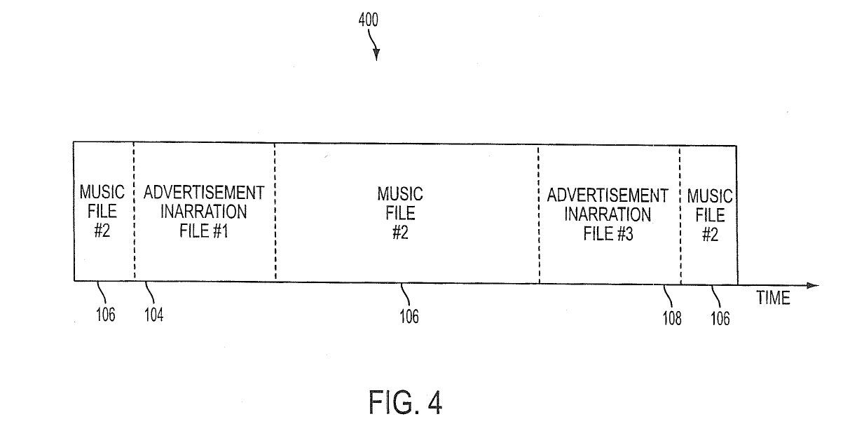

FIG. 4 is a timeline showing a temporal configuration of a first embodiment of a Bannered File 400 as a complete Digital Music Package. In this diagram, the playback sequence starts with a segment of the master File #2 106, followed by playback of media Banner File #1 104, followed by another segment of the master File #2 106, followed by media Banner File #3 108, followed by a final segment of master File #2 106.

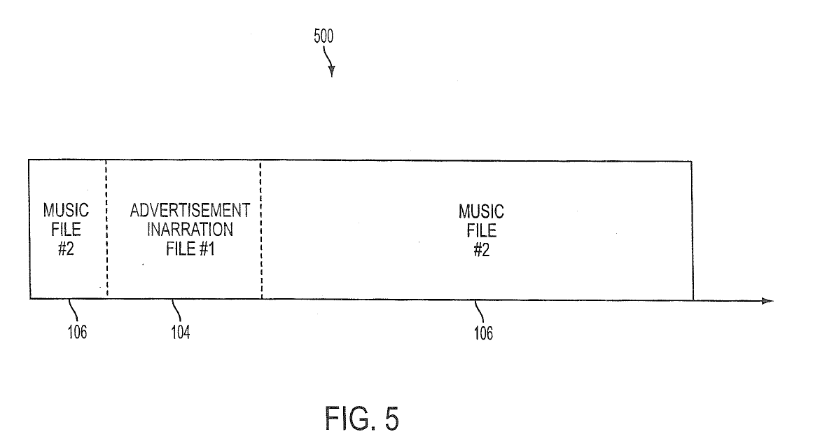

FIG. 5 is a timeline showing a third embodiment of a temporal configuration of a Bannered File 500 as a complete Digital Music Package. In this diagram, the playback sequence starts with a segment of media File #2 106, followed by media Banner File #1 104, followed by a final segment of master File #2 106.

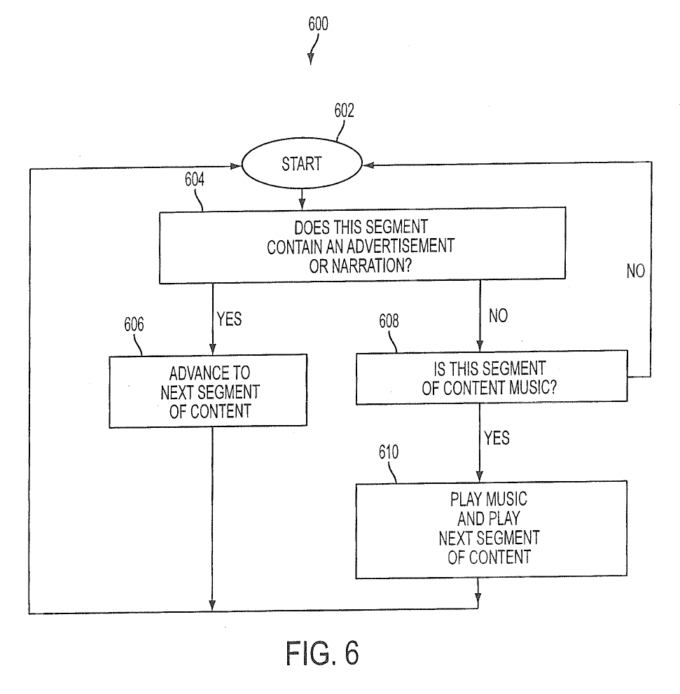

With combined media, it may be desirable to only listen to or observe parts of the combined media. FIG. 6 is a flow chart 600 that illustrate the functionality of filters on the playback of a Package, in an embodiment. This filter screens the content of a package and plays back only the music content, effectively eliminating narration or advertising from the playback sequence. After a start operation 602, the filter tests to see of a segment contains an advertisement/narration, via operation 604. If the segment does contain an advertisement or narration, then the next segment is advanced to at operation 606. Control is then returned to operation 602. If the segment does not contain an advertisement/narration, then the filter sees if the segment contains music at operation 608. If no, control is returned to operation 602. If yes, then the music is played followed by the next segment at operation 610. Control is then again returned to operation 602.

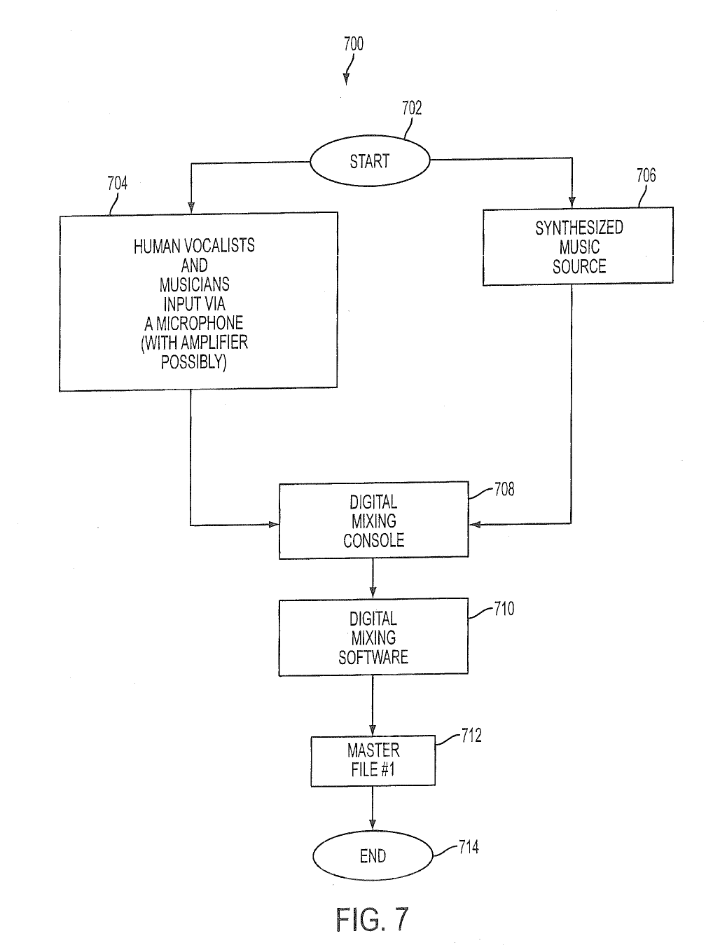

The combined media may be created in a variety of ways, to produce a file that is a serial compilation of source material, an interleaved compilation, or some other combination. FIG. 7 is a block diagram 700 that demonstrates how a Music File is created, in an embodiment. One or more human vocalists or musicians sing or play into microphones, with or without amplification. A synthesized music source can also provide music input. Those sources of an audio stream feed into a mixing console; examples of commercial audio mixing consoles are the Alesis Studio 32 Recording Console, the Amek Mozart Master Recording Console, and the Mackie D8B 56 Input/72 Channel Digital Mixer. The audio mixing console creates a digital audio representation from the audio stream input. It's output file is imported into digital mixing software; examples of commercial digital mixing software are Digital Performer and Pro Tools. The digital mixing software is used to edit imperfections from the music, to blend and harmonize the different sources of music, and to select preferred performances from various versions of the music. Output from the digital mixing software is a master file that can be commercially used as a Music File.

Starting at operation 702, two sources are input using operation 704 that includes vocalists and musicians into a microphone (possibly with an amplifier) and a synthesized music source via operation 706. The two sources are then combined via a digital mixing console at an operation 708. At operation 710 the output of the digital mixing console is further mixed and encoded utilizing software. A master file #1 is then created at an operation 712 and the process ends at step 714.

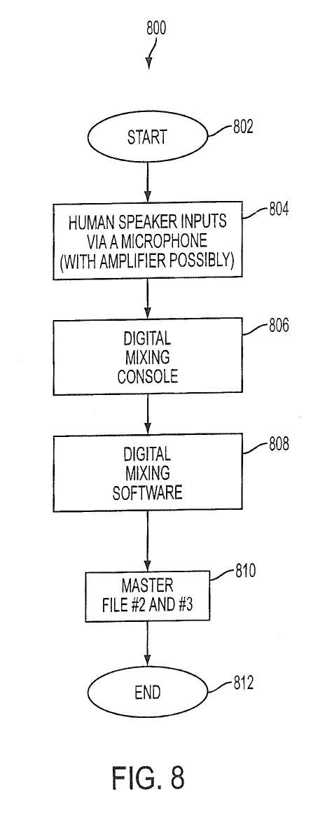

Components of the combined media files may be created in different ways, too. FIG. 8 is a block diagram 800 that demonstrates how an Audio Banner file is created, in an embodiment. A human speaker/narrator speaks words into a microphone, with or without amplification. That audio stream feeds into an audio mixing console; examples of commercial audio mixing consoles are the Alesis Studio 32 Recording Console, the Amek Mozart Master Recording Console, and the Mackie D8B 56 Input/72 Channel Digital Mixer. The audio mixing console creates a digital audio representation from the audio stream input. It's output file is imported into digital mixing software; examples of commercial digital mixing software are Digital Performer and Pro Tools. The digital mixing software is used to edit imperfections from the narration, and the output is a master file that can be commercially used as an Audio Banner File.

After a start operation 802, a human speaker inputs voice via a microphone, possibly with an amplifier, at an operation 804. It is then mixed at an operation 806 and possibly further mixed and encoded utilizing software at an operation 808. Media files #1 and #3 are then output via operation 810. The process then ends at operation 812.

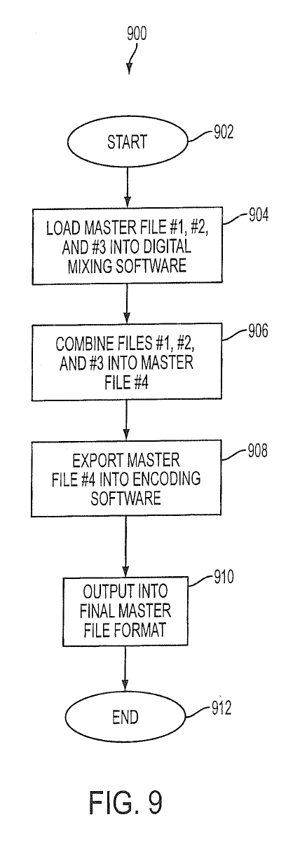

Similarly, media files such as music may be created in various ways. FIG. 9 is a block diagram 900 that demonstrates how a Digital Music Package is created, in an embodiment. Using master files created using the approach in FIG. 7 and FIG. 8, the files input into digital mixing software (examples provided above). The digital mixing software is used to combine the master files into a single master file. That master file is exported into encoding software; examples of commercial encoding software are MP3 Rage and the Apple Music Store Encoder.

After an initial start operation 902, master files #1, #2 and #3 are loaded into and manipulated by digital mixing and editing software at an operation 904. Files #1, #2 and #3 are then combined into master file #4 at operation 906. Master file #4 is then exported into encoding software and output into a final master file format via operations 908 and 910. The process then ends at operation 912.

A single file can be created and propagated without the need to locate and manipulate multiple files. Additionally, an audio file can be overlayed such that both streams can be heard via a single file without the need to setup multiple streams. Moreover, other types of media files, such as video files or audiovisual files may be manipulated in a manner similar to that described above with respect to audio files. This may include interleaving or serial combination, and may include superimposition of parts of one media source file on another media source file in the resulting combined media file.

While this invention has been described in terms of certain preferred embodiments, it will be appreciated by those skilled in the art that certain modifications, permutations and equivalents thereof are within the inventive scope of the present invention. It is therefore intended that the following appended claims include all such modifications, permutations and equivalents as fall within the true spirit and scope of the present invention.

1. A method of enhancing a media file with intrinsic supplementary content, comprising:
obtaining a media file; and
combining supplementary content with the media file to create a compressed unitary media file with supplementary content.

2. The method of claim 1, wherein:
the supplementary content includes a first supplementary media file and a second supplementary media file.

3. The method of claim 2, wherein:
the first supplementary media file is an advertisement.

4. The method of claim 2, wherein:
the first supplementary media file is commentary.

5. The method of claim 3, wherein:
the second supplementary media file is an advertisement.

6. The method of claim 3, wherein:
the second supplementary media file is commentary.

7. The method of claim 4, wherein:
the second supplementary media file is an advertisement.

8. The method of claim 1, wherein:
combining supplementary content with the media file includes:
loading the supplementary content;
loading the media file;
forming a unitary file with supplementary content including the media file and the supplementary content;
compressing the unitary media file with supplementary content to form a compressed unitary media file with supplementary content; and
exporting the compressed unitary with supplementary content.

9. The method of claim 8, wherein:
compressing the unitary media file with supplementary content includes encoding the unitary media file with supplementary content.

10. A method comprising:
receiving a media file;
receiving a first supplemental media file; and
combining the media file with the first supplemental media file to form a combined media.

11. The method of claim 10, further comprising:
receiving a second supplemental media file; and
combining the media file with the first supplemental media file to form a combined media file further includes combining the media file with the first supplemental media file and the second supplemental media file to form the combined media file.

12. The method of claim 10, wherein:
the first supplemental media file is an advertisement.

13. The method of claim 10, wherein:
the first supplemental media file is an commentary.

14. The method of claim 11, wherein:
the first supplemental media file is an advertisement and the second supplemental media file is an advertisement.

15. The method of claim 11, wherein:
the first supplemental media file is commentary and the second supplemental media file is commentary.

16. The method of claim 19, wherein:
combining the first media file with the first supplemental media file to form the combined media file includes:
loading the media file;
loading the first supplemental media file;
forming a combined media file including the media file and the first supplemental media file; and
encoding the combined media file.

17. A system, comprising:
a processor;
a memory coupled to the processor;
a network interface coupled to the processor;
and wherein the processor is to:
receive a media file;
receive a first supplemental media file; and
combine the media file with the first supplemental media file to form a combined media file.

18. The system of claim 17, wherein:
the processor is further to:
receive a second supplemental media file; and
combine the media file with the first supplemental media file and the second supplemental media file to form the combined media file.

19. The system of claim 18, wherein
the processor is operative to:
load the media file;
load the first supplemental media file;
form a combined media file including the media file and the first supplemental media file; and
encode the media file.

20. An apparatus, comprising:
means for receiving media files;
means for combining media files; and
means for exporting media files.

21. The method of claim 1, wherein at least one of the media file and the supplementary content comprises video content.

22. The method of claim 1, wherein at least one of the media file and the supplementary content comprises audio content.

23. The method of claim 2, wherein at least one of the media file, the first supplementary media file and the second supplementary media file comprises at least one of video content and audio content.

24. The method of claim 1, wherein:
the supplementary content is combined with the media file such that at least a portion of a time index of the supplementary content overlaps with a time index of the media file.
